(19) United States
(12) Patent Application Publication
(10) Pub. No.: US 2018/0004995 A1
(43) Pub. Date: Jan. 4, 2018

(54) SYSTEMS AND METHODS FOR DETECTING DOUBLE-FEED ITEMS ON MAIL PROCESSING EQUIPMENT

(71) Applicant: Siemens Industry, Inc., Alpharetta, GA (US)

(72) Inventor: Peter Parker, Keller, TX (US)

(21) Appl. No.: 15/415,138

(22) Filed: Jan. 25, 2017

Related U.S. Application Data
(60) Provisional application No. 62/355,983, filed on Jun. 29, 2016.

(51) Int. Cl. G06K 7/10; B07C 3/10; G06K 9/00

(52) U.S. Cl. CPC G06K 7/10762; G06K 9/00442; B07C 3/10; G06K 7/10861; B07C 2301/0066

(57) ABSTRACT

A method for detecting double-fed mail pieces. The method includes receiving a first mail piece and a second mail piece together as a combined mail piece and scanning both sides of the combined mail piece to determine and store a first side identifier and a second side identifier. The method includes separately scanning the first mail piece to determine the first side identifier and a different second side identifier and separately scanning the second mail piece to determine the second side identifier and a different first side identifier. The method includes querying the identifier database using the first side identifier to retrieve the second side identifier associated with the combined mail piece and determining that the different second side identifier is now associated with the separate second mail piece. The method includes identifying the first mail piece or the second mail piece as a double feed mail piece.

### CROSS-REFERENCE TO RELATED APPLICATION

This application claims the benefit of the filing date of United States Provisional Patent Application 62/355,983, filed Jun. 29, 2016, which is hereby incorporated by reference.

### TECHNICAL FIELD

Aspects of the present invention generally relate mail processing, and more specifically, to the detection of double-fed mail items.

### BACKGROUND OF THE DISCLOSURE

In mail processing systems, two mail items, such as two letters, can be “double-fed,” that is, processed together when they should be processed separately. This can happen, for example, if two letters are stuck together. In such cases, one or both of the items is typically sorted or otherwise processed incorrectly. Improved systems are desirable.

### SUMMARY OF THE DISCLOSURE

Disclosed embodiments relate to systems and method for detecting double-fed mail pieces. A method includes receiving a first mail piece and a second mail piece together as a combined mail piece in a first automation pass. The method includes scanning both sides of the combined mail piece to determine a first side identifier and a second side identifier, wherein the first side identifier is determined from the first side of the first mail piece and the second side identifier is determined from the second side of the second mail piece. The method includes storing the first side identifier and the second side identifier in an identifier database as associated with the combined mail piece. The method includes separately scanning the first mail piece to determine the first side identifier and a different second side identifier, in a second automation pass after the first mail piece has separated from the second mail piece. The method includes separately scanning the second mail piece to determine the second side identifier and a different first side identifier, in the second automation pass after the first mail piece has separated from the second mail piece. The method includes querying the identifier database using the first side identifier to retrieve the second side identifier associated with the combined mail piece. The method includes determining that the different second side identifier is now associated with the separate second mail piece. The method includes identifying at least one of the first mail piece or the second mail piece as a double feed mail piece.

In some embodiments, the automation system also determines that the different second side identifier is different from the second side identifier associated with the combined mail piece. wherein at least one of the first side identifier and the second side identifier is an image attribute fingerprint. In some embodiments, at least one of the first side identifier and the second side identifier is derived from a concatenation of the name and address data of a recipient of the first mail piece. In some embodiments, at least one of the first side identifier and the second side identifier is an indicia printed on the first mail piece. In some embodiments, at least one of the first side identifier and the second side identifier is an ultraviolet ID tag. In some embodiments, the identified double feed mail piece is sorted for special processing. In some embodiments, the first side is a front of the first mail piece.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example of a mail processing automation system in accordance with disclosed embodiments;

FIG. 2 shows an example of imaging in an automation first pass in which a single-fed letter occurs in accordance with disclosed embodiments;

FIG. 3 shows an automation first pass in which a double feed occurs in accordance with disclosed embodiments;

FIG. 4 shows an automation second pass in which the previously double fed items have become separated in the mail stream in accordance with disclosed embodiments;

FIG. 5 illustrates a flowchart of a process in accordance with disclosed embodiments; and

FIG. 6 depicts a block diagram of a data processing system 600 in which an embodiment can be implemented.

### DETAILED DESCRIPTION

The figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Mail processing typically involves the separation of a stack of letters into individual letters that are then oriented so they can be fed into a high speed mail transport for automation processing. Separation of individual letters is an inherently difficult process due to the widely varying physical nature of letters, such as varying letter size, friction, and thickness, and the limitation of current separator equipment. Frequently, such automation equipment fails to completely separate the letters and one or more letters may be fed and presented to the automation equipment as if it were a single piece, referred to as a double-feed.

Double-fed letters inherently cause at least one of the letters to be mis-sorted as it moves through various automation equipment. These mis-sorted items frequently do not get detected until the letter is handled by the letter carrier at which point they are re-inserted back into the automation stream for re-processing. This additional handling step reduces productivity, delays mail delivery, and represents additional costs.

There are multiple automation passes that a letter usually moves through before the postal carrier actually receives the letter. At each subsequent pass, items which were previously double fed often become separable and then move through the automaton processes as individual letters. In some cases, such as Postal Automated Redirection System (PARS) processing, this separated piece can be incorrectly identified as the original double-fed letter, causing costly mis-sorts, or even mislabeling.

Various real-time doubles detection techniques are employed to detect these anomalies and separate the double feed items. But these techniques frequently fail to detect the double feeds. These techniques vary from mechanical to sophisticated, but in general they generally rely on detecting some physical characteristic that a double feed represents. Other techniques use digital imaging and processing to determine some visual feature that indicates a high probability of double feed.

As described above, various techniques can be used to detect doubles. “Over-length” detection detects doubles by noting that the item has a measured length that exceeds a pre-determined maximum letter length.

“Bottom-edge” detection detects doubles by imaging/scanning the bottom edge of the mail piece and performing image processing to determine mail piece edges, to ensure that only one edge is present. If more than one edge is detected, then the scanned mail piece is likely a double. One example of a bottom-edge detector is the Combined Input Output Subsystem (CIOSS) double detector developed by Siemens.

“Face-side” detection detects doubles by imaging/scanning the face side of the mail piece and using image processing algorithms to determine double feeds by extracting and examining letter features, such as multiple address blocks, abrupt feature changes, and document edge, that are evident when the double-fed items overlap within the field of view.

Ultrasound detection detects doubles by passing ultrasound through the document and measuring the response. A double is detected as a diminished response due to the air gap between documents. This type of detector is more suitable to sheet-feed applications and not very suitable to letter mail technology.

None of these techniques is completely accurate, and often a double will go undetected at a first point in processing, and the mail pieces will later separate during processing. The capability to detect previously-undetected doubles that have since separated is a distinct technical improvement in the operation of the mail processing system.

One approach to solving the double feed problem is to examine adjacent letter properties of the letters after they separate on subsequent automation passes, but before they reach the carrier. Once detected, these letters can either be automatically corrected for proper sorting, or sorted into a reject bin for re-processing. The intent of this technique is not to replace existing double detection equipment, but to supplement it in the automation stream.

Disclosed embodiments detect previously-undetected double feeds during subsequent mail processing passes after the double-fed items have again separated within the mail stream. It achieves this by determining that these now-separate, but physically-adjacent, mail pieces have identifying features that can only belong to a pair of mail pieces that were previously double fed but undetected as a double on the previous mail processing pass.

Once this determination has been made, both items can either be separated to a culling bin as double-feed items or the double feed can be automatically corrected.

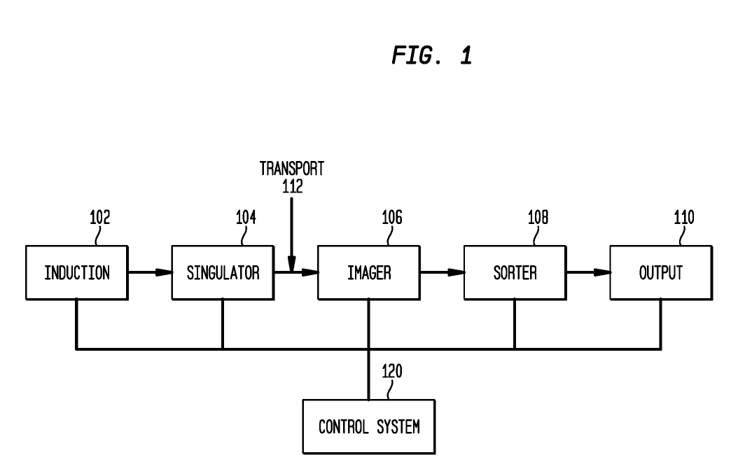

FIG. 1 illustrates an example of a mail processing automation system 100. In this system, mail pieces are received at induction 102, then are singulated at singulator 104. The singulated mail pieces are transported through the system on transport 112, which can be, for example, a series of pinch belts or other transport mechanisms.

Each element in the FIG. 1 automation system can be implemented by different devices, or one or more elements can be integrated. For example, imager 106 can be part of sorter 108. Each element is controlled by a control system 120, which can be implemented by one or more controllers.

The mail pieces are imaged by imager 106. According to disclosed embodiments, both sides of each mail pieces are imaged or scanned. In some cases, this can include printing a visible or invisible barcode or other indicia on either or both sides of each mail piece, and can include reading previously-printed indicia. The mail processing system stores a “first side” identifier and a “second side” identifier for each mail piece (e.g., a front side identifier and a back side identifier), and associates these identifiers with a unique mail piece identifier for each mail piece. Any of these identifiers can be the printed or read indicia. In some cases, for example, the side A identifier can be the unique identifier, associated with the corresponding side B identifier.

For example, other techniques for forming a first side or second side identifier can include using the “Fingerprint” technology developed by Siemens Corporation (“ArtID”) or using a concatenation of the recipient name and address data. The Siemens Fingerprint technology creates a unique fingerprint of the face of each mailpiece based on image attributes. This fingerprint can be used as the first side and/or second side identifier. The concatenation of the name and address data, acquired using OCR and/or video coding, takes the information within the recipient address block and creates an identifier, so the identifier is derived from this information. The fingerprint can be formed, for example, after the first scanning described herein. The registration identifier is associated with the pattern, location, and/or contents of visible indicia on the respective mail piece that can be derived from the respective images. Other information on the mailpiece, such as the sender address information, may also be attached to the recipient address block information, to create a stronger identifier.

The control system 100 stores the identifiers. The mail pieces are sorted at sorter 108 to outputs 110, using conventional techniques.

The process described above is a “single pass” of a typical sort process. In typical mail processing, more than one pass is performed. A subsequent pass can be performed by putting the sorted mail pieces back through automation system 100, or be performed by a second mail processing system 100, or can be performed in a single mail processing system 100 by duplicating some of the elements above. In accordance with disclosed embodiments, the mail pieces are imaged twice, at two different points in time, as described in more detail below.

The mail processing system can include conventional doubles detection processes and devices. However, as described above, such conventional techniques are not always successful at identifying doubles, and so a double may be processed through all or part of the process described above as if it were a single mail piece.

The disclosed doubles detection technique identifies items that have separated in the automation stream, but were previously undetected double feeds on a prior automation pass. To do this, the automation system stores the side A and side B identifiers (IDs) on the first automation pass where the double occurs. In certain embodiments, the backside identifier technology is an ultraviolet (UV) ID tag, and the front side identification technology is the Siemens ArtID “fingerprint” technology described above, though any other suitable technologies would work as well.

As described above, the backside (second side) identifier is a UV barcode in certain embodiments. Either this barcode pre-exists at the first pass, or, in some cases, it is printed on the mail piece. This identifier is guaranteed to be unique across the entire country for 30 days, and so it serves as a positive ID to distinguish this piece from all others. It is not necessary to separately store this identifier in a database in some embodiments; it is sufficient merely to be able to read it whenever the mailpiece is processed.

In “fingerprint” embodiments, the front side identifier (first side ID) is an ID that is determined using characteristics, features or other attributes of the image of the front side. During the first pass, the front side image is scanned and a unique ID is associated with the extracted image features. Both the image features and the ID are stored together in a database. In later passes, given the same set of image features, the database can return the associated ID for that mail piece.

In various embodiments, the ID that is associated with the image features is the same as the ID from the back side UV barcode (second-side ID), and this fact is used in performing subsequent doubles detection. This means that the back side ID (UV barcode), and the front side ID (the ID returned from the database) should be the same for any given mail piece.

If the previously-determined front side ID and back side ID for a mail piece do not match, there are several possibilities. For example, this could mean that either the front side ID or back side ID is unreadable. For example, the UV barcode may be damaged, or the front side image has been defaced or is otherwise not a suitable match for image features stored in the database.

As another example, this could mean that the original front side association was incorrect because the original scan was a double feed. In order to determine if this scenario is the case, the system examines adjacent mailpieces IDs. If an adjacent mail piece has a back side ID that matches the current front side ID, then there is a high degree of confidence that the original pass was, in fact, a double feed, because the same ID (or associated IDs) is found on two physically different mailpieces, each on a different side. Note that some mail processing equipment reverses the mail piece “deck” order anytime it is run, so in a second pass case, the system looks at foregoing mail piece back side ID versus the current front side ID. For this reason, the front side and back side IDs can be considered interchangeable when performing a verification lookup. In actual implementation, the system can determine a double feed when the current back side ID matches the previous mail piece's front side ID or when the current front side ID matches previous mail piece's back side ID.

In various embodiments, the system identifies opposite side IDs that match on adjacent mailpieces, which should never happen unless those mail pieces were originally a double feed.

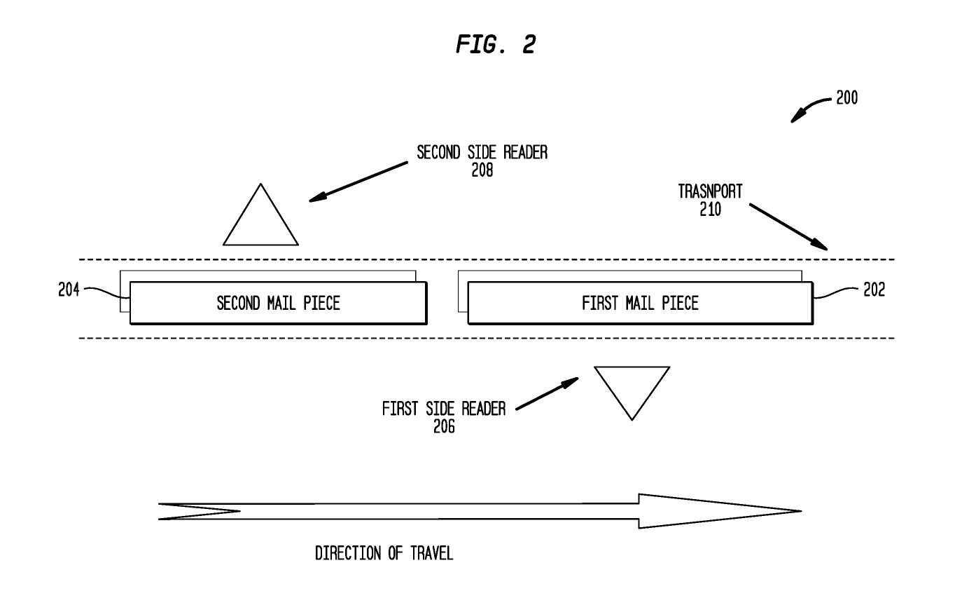

FIG. 2 shows an example of imaging in an automation first pass in which a single-fed letter occurs, such as could be performed in imager 106. A second side ID tag reader 208 reads a pre-printed ID tag of first mail piece 202 and associates this identifier with this letter, such as by storing a second side ID associated with a first mail piece ID. A first side reader 206, such as an ArtID front side reader technology, then performs “registration”—digital image processing—on the front side to produce a first side ID and associates the second side ID with the first side ID. In this particular example, the first side ID, represented as image attributes, is associated with the second side ID represented by the UV ID tag.

First side reader 206 and second side reader 208 can be implemented using cameras or other imaging devices known to those of skill in the art. Note that in this figure, for illustrative purposes, front side reader 206 is shown as offset from second side reader 208, and reads each mail piece after second side reader 208 in the mail piece direction of travel. This particular arrangement is not necessary or limiting; disclosed embodiments can place the front side reader 206 and second side reader 208 in any position with relation to each other, including placing them so both sides of the mail piece are images at the same time.

The first side ID, such as image attributes (or “fingerprint”) of the first side, and corresponding second side ID are stored together in a database for the first mail piece 202, along with any separate unique identifier, if such a unique identifier is used separately from the first side ID and second side ID. This means that mail piece 202 can now be identified in subsequent passes by either front side ID alone or the second side ID alone, by querying the database with the ID(s) read in the subsequent pass. The first and second IDs are essentially “married” to each other for the automation lifetime of the mail piece 202.

The same process is performed for second mail piece 204.

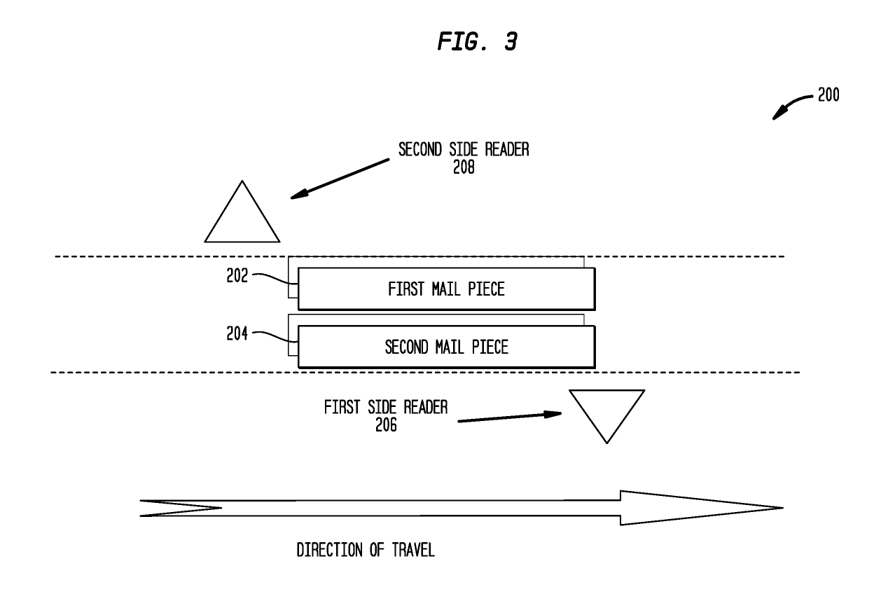

FIG. 3 shows an automation first pass in which a double feed occurs, using similar references as FIG. 2, with first mail piece 202 attached as a double to second mail piece 204. In this case, the second side reader 208 reads the second side of first mail piece 202 and the first side reader 206 reads the first side of second mail piece 204, but the automation system sees this double as a single mail piece.

In this example, the second side mail piece (first mail piece 202) has its second side ID associated with the front side letter (second mail piece 204) front side ID since the double is read as a single mail piece. These two mail pieces then travel together as a single mail piece into a single sorter bin and will be processed again on a subsequent automation pass. At this point, the double is still undetected.

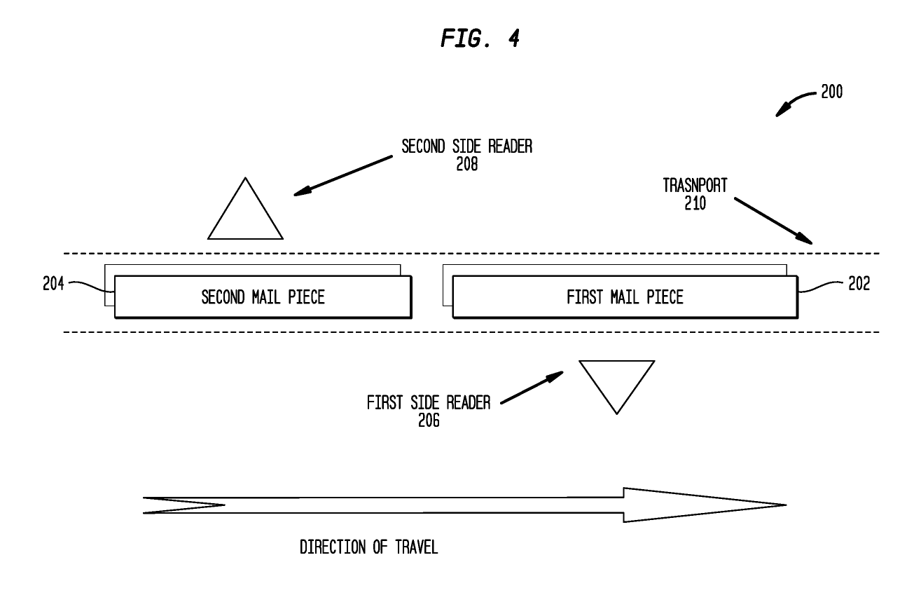

FIG. 4 shows an automation second pass in which the previously double fed items have become separated in the mail stream. Note that this case reflects the “normal” case of FIG. 2, since the previously-doubled mail pieces are separated. In this pass, for each letter, the imager 106 reads the second sider ID, and, using the front side ID, also queries the database in an attempt to identify the piece using the front side ID. Depending on the type of sorter technology used, the ordering of the first side and second side (front and back sides) may be reversed.

At this point, the system identifies any previous doubles. In a normal single feed, no two adjacent mail pieces should ever have the same unique ID or corresponding first side and second side identifiers. If such a sequence occurs, the two letters must have been a double feed on the first registration pass. As the first mail piece 202 and second mail piece 204 are imaged as described above in FIG. 2, each of the identifiers are looked up in the ID database. If first mail piece 202 has a first side ID that matches the second sider ID of the second mail piece 204, or vice-versa, a double feed is identified and the mail pieces are sorted to a special pocket, or, in the case of the CIOSS label pass, one or both of the mail pieces can be prevented from being mis-labeled (and out-sorted for special handling), or one of the mail pieces can continue on as a correctly-labeled mail piece. In alternate embodiments, a double feed can be detected when a first side ID for a single mail piece does not match the stored second side ID for the same mail piece (or vice versa).

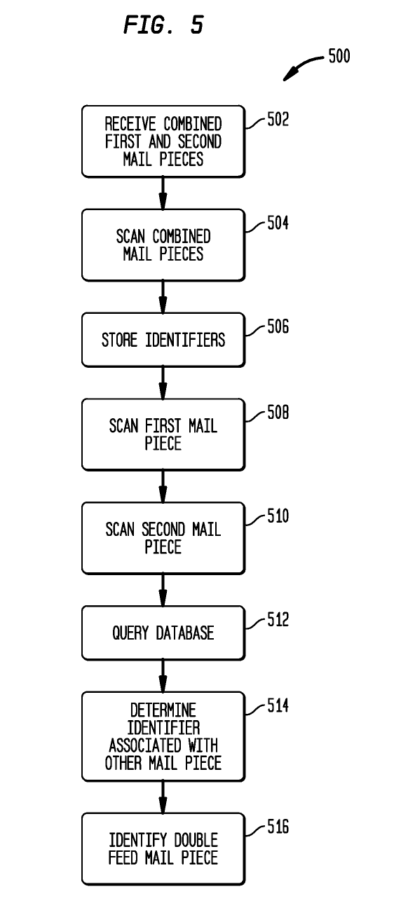

FIG. 5 illustrates a flowchart of a process in accordance with disclosed embodiments that can be performed by an automation system as in FIG. 1. Note that while this process is described in terms of a two mail pieces first that are double-fed, the process naturally will be performed for any mail pieces that are received for processing.

In a first automation pass, receiving a first mail piece and a second mail piece together as a combined mail piece (a double) (502).

Scanning both sides of the combined mail piece to determine a first side identifier and a second side identifier (504), wherein the first side identifier is determined from the first side of the first mail piece and the second side identifier is determined from the second side of the second mail piece. “Scanning” can include full imaging, reading a bar code or other indicia, or other techniques for determining the identifiers.

Storing the first side identifier and the second side identifier in an identifier database as associated with the combined mail piece (506).

In a second automation pass, after the first mail piece has separated from the second mail piece, separately scanning the first mail piece to determine the first side identifier and a different second side identifier (508). “Separately scanning,” in this context, means the two mail pieces are not scanned as a single, combined mail piece.

In the second automation pass, after the first mail piece has separated from the second mail piece, separately scanning the second mail piece to determine the second side identifier and a different first side identifier (510).

Querying the identifier database using the first side identifier to retrieve the second side identifier associated with the combined mail piece (512).

Determining that the different second side identifier is now associated with the separate second mail piece (514). Alternately or additionally, the automation system determines that the different second side identifier is different from the second side identifier associated with the combined mail piece.

Identifying at least one of the first mail piece or the second mail piece as a double feed mail piece (516). This can include sorting at least one of the first mail piece or the second mail piece for special processing.

Note that in the description above, the “first” and “second” labels are arbitrary, and the process can encompass any subsequent automation pass in which the two identifiers previously associated with a “single” mail piece are later associated with different mail pieces. Similarly, the “first” and “second” automation passes can refer to any different points in time in which the mail pieces are processed as described.

As described herein, any suitable technology can be used to render a front side ID or back side ID, though the UV tags and image attributes are used in specific examples above. Disclosed embodiments obtain both a front side ID and a back side ID, and that in the event of a double-feed that subsequently separates, these two IDs appear on two different physically mailpieces, which are typically physically adjacent to each other in the mail stream. Disclosed embodiments are not used to detect the initial double feed, but rather detect the subsequently=separated pieces that originally appeared as a single, double-fed piece.

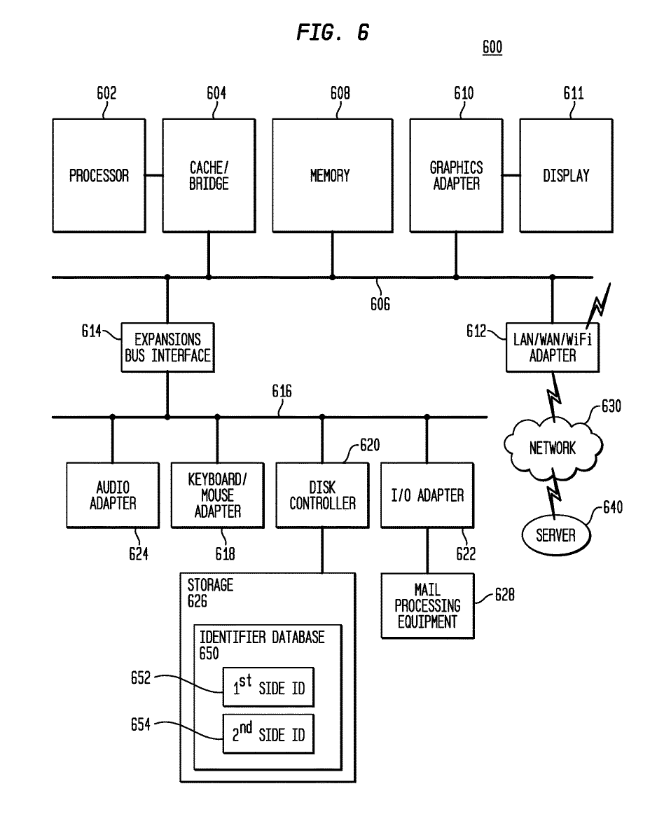

FIG. 6 depicts a block diagram of a data processing system 600 in which an embodiment can be implemented, for example as a system for implementing control system 120, or one of the other systems or elements described herein, and can be configured to perform processes as described herein. Data processing system can be used to implement one of multiple data processing systems in cloud computing system 212. The data processing system depicted includes a processor 602 connected to a level two cache/bridge 604, which is connected in turn to a local system bus 606. Local system bus 606 may be, for example, a peripheral component interconnect (PCI) architecture bus. Also connected to local system bus in the depicted example are a main memory 608 and a graphics adapter 610. The graphics adapter 610 may be connected to display 611.

Other peripherals, such as local area network (LAN)/Wide Area Network/Wireless (e.g. WiFi) adapter 612, may also be connected to local system bus 606. Expansion bus interface 614 connects local system bus 606 to input/output (I/O) bus 616. I/O bus 616 is connected to keyboard/mouse adapter 618, disk controller 620, and I/O adapter 622. Disk controller 620 can be connected to a storage 626, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 626 can store and maintain an identifier database 650 as described herein, which can store a first side ID 652 and a second side ID 654.

I/O adapter 622 can be connected to mail processing equipment 628, which can include any of the elements of FIG. 1 or other hardware devices for processing mail pieces forms in accordance with the various embodiments described herein.

Also connected to I/O bus 616 in the example shown is audio adapter 624, to which speakers (not shown) may be connected for playing sounds. Keyboard/mouse adapter 618 provides a connection for a pointing device (not shown), such as a mouse, trackball, trackpointer, etc.

Those of ordinary skill in the art will appreciate that the hardware depicted in FIG. 6 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 612 can be connected to a network 630 (not a part of data processing system 600), which can be any public or private data processing system network or combination of networks, as known to those of skill in the art, including the Internet. LAN/WAN/Wireless adapter 612 can also communicate with packages as described herein, and perform other data processing system or server processes described herein. Data processing system 600 can communicate over network 630 with one or more server systems 640, which are also not part of data processing system 600, but can be implemented, for example, as separate data processing systems 600. A server system 640 can be, for example, any of the other systems described herein, and so indicates how systems can intercommunicate over network 630.

It is important to note that while the disclosure includes a description in the context of a fully functional system, those skilled in the art will appreciate that at least portions of the mechanism of the present disclosure are capable of being distributed in the form of a computer-executable instructions contained within a machine-usable, computer-usable, or computer-readable medium in any of a variety of forms to cause a system to perform processes as disclosed herein, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs). In particular, computer readable mediums can include transitory and non-transitory mediums, unless otherwise limited in the claims appended hereto. For example, various embodiments include systems, methods, and computer-readable media.

Although an exemplary embodiment of the present disclosure has been described in detail, those skilled in the art will understand that various changes, substitutions, variations, and improvements disclosed herein may be made without departing from the spirit and scope of the disclosure in its broadest form. In the processes described above, various steps may be performed sequentially, concurrently, in a different order, or omitted, unless specifically described otherwise. Similarly, various elements of the systems and apparatuses described herein can be duplicated, rearranged, or omitted in various embodiments, unless described or claimed otherwise.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. A method for detecting double-fed mail pieces, comprising:
receiving a first mail piece and a second mail piece together as a combined mail piece in a first automation pass;
scanning both sides of the combined mail piece to determine a first side identifier and a second side identifier, wherein the first side identifier is determined from the first side of the first mail piece and the second side identifier is determined from the second side of the second mail piece;
storing the first side identifier and the second side identifier in an identifier database as associated with the combined mail piece;
separately scanning the first mail piece to determine the first side identifier and a different second side identifier, in a second automation pass after the first mail piece has separated from the second mail piece;
separately scanning the second mail piece to determine the second side identifier and a different first side identifier, in the second automation pass after the first mail piece has separated from the second mail piece;
querying the identifier database using the first side identifier to retrieve the second side identifier associated with the combined mail piece;
determining that the different second side identifier is now associated with the separate second mail piece; and
identifying at least one of the first mail piece or the second mail piece as a double feed mail piece.

2. The method according to claim 1, wherein the automation system also determines that the different second side identifier is different from the second side identifier associated with the combined mail piece.

3. The method according to claim 1, wherein at least one of the first side identifier and the second side identifier is an image attribute fingerprint.

4. The method according to claim 1, wherein at least one of the first side identifier and the second side identifier is derived from a concatenation of the name and address data of a recipient of the first mail piece.

5. The method according to claim 1, wherein at least one of the first side identifier and the second side identifier is an indicia printed on the first mail piece.

6. The method according to claim 1, wherein at least one of the first side identifier and the second side identifier is an ultraviolet ID tag.

7. The method according to claim 1, wherein the identified double feed mail piece is sorted for special processing.

8. The method according to claim 1, wherein the first side is a front of the first mail piece.

9. A mail processing automation system, comprising:
an imager;
a control system connected to control the imager; and
an identifier database stored in the control system, wherein the automation system is configured to:
receive a first mail piece and a second mail piece together as a combined mail piece in a first automation pass;
scan both sides of the combined mail piece with the imager to determine a first side identifier and a second side identifier, wherein the first side identifier is determined from the first side of the first mail piece and the second side identifier is determined from the second side of the second mail piece;
store the first side identifier and the second side identifier in the identifier database as associated with the combined mail piece;
separately scan the first mail piece with the imager to determine the first side identifier and a different second side identifier, in a second automation pass after the first mail piece has separated from the second mail piece;
separately scan the second mail piece with the imager to determine the second side identifier and a different first side identifier, in the second automation pass after the first mail piece has separated from the second mail piece;
query the identifier database using the first side identifier to retrieve the second side identifier associated with the combined mail piece;
determine that the different second side identifier is now associated with the separate second mail piece; and
identify at least one of the first mail piece or the second mail piece as a double feed mail piece.

10. The automation system according to claim 9, wherein the automation system also determines that the different second side identifier is different from the second side identifier associated with the combined mail piece.

11. The automation system according to claim 9, wherein at least one of the first side identifier and the second side identifier is an image attribute fingerprint.

12. The automation system according to claim 9, wherein at least one of the first side identifier and the second side identifier is derived from a concatenation of the name and address data of a recipient of the first mail piece.

13. The automation system according to claim 9, wherein at least one of the first side identifier and the second side identifier is an indicia printed on the first mail piece.

14. The automation system according to claim 9, wherein at least one of the first side identifier and the second side identifier is an ultraviolet ID tag.

15. The automation system according to claim 9, wherein the identified double feed mail piece is sorted for special processing.

16. The automation system according to claim 9, wherein the first side is a front of the first mail piece.

17. A computer-readable storage medium storing executable instructions that, when executed, cause an automation system to:
receive a first mail piece and a second mail piece together as a combined mail piece in a first automation pass;
scan both sides of the combined mail piece with an imager to determine a first side identifier and a second side identifier, wherein the first side identifier is determined from the first side of the first mail piece and the second side identifier is determined from the second side of the second mail piece;
store the first side identifier and the second side identifier in the identifier database as associated with the combined mail piece;
separately scan the first mail piece with the imager to determine the first side identifier and a different second side identifier, in a second automation pass after the first mail piece has separated from the second mail piece;
separately scan the second mail piece with the imager to determine the second side identifier and a different first side identifier, in the second automation pass after the first mail piece has separated from the second mail piece;
query the identifier database using the first side identifier to retrieve the second side identifier associated with the combined mail piece;
determine that the different second side identifier is now associated with the separate second mail piece; and
identify at least one of the first mail piece or the second mail piece as a double feed mail piece.

18. The computer-readable storage medium according to claim 17, wherein at least one of the first side identifier and the second side identifier is an image attribute fingerprint.

19. The computer-readable storage medium according to claim 17, wherein at least one of the first side identifier and the second side identifier is derived from a concatenation of the name and address data of a recipient of the first mail piece.

20. The computer-readable storage medium according to claim 17, wherein at least one of the first side identifier and the second side identifier is an indicia printed on the first mail piece.
